(19) United States
(12) Patent Application Publication
(10) Pub. No.: US 2002/0061261 A1
(43) Pub. Date: May 23, 2002

(54) Apparatus for receiving microdissected specimens

(76) Inventors: Gerhard Pfeifer, Solms (DE); Albrecht Weiss, Linden (DE)

Correspondence Address: DAVIDSON, DAVIDSON & KAPPEL, LLC, 485 SEVENTH AVENUE, 14TH FLOOR, NEW YORK, NY, 10018, US

(21) Appl. No.: 10/002,539

(22) Filed: Nov. 15, 2001

(30) Foreign Application Priority Data
Nov. 17, 2000 (DE) DE100 57 292.8-52

(51) Int. Cl. B01L 3/00

(52) U.S. Cl. 422/102

(57) ABSTRACT

The apparatus (10) for receiving microdissected specimens is equipped with at least one receptacle (12) for collection. The apparatus (10) is arranged displaceably in an open space (32) defined by a stage surface (4) of an X-Y stage (2) and a contamination shielding panel (42). The receptacle (12) is arranged on a separate holding element (54) in the apparatus, and by shifting the apparatus (10), one holding element (54) at a time can be brought into a collection position.

### CROSS REFERENCE TO RELATED APPLICATIONS

This invention claims priority of the German patent application 100 57 292.8-52 which is incorporated by reference herein.

### FIELD OF THE INVENTION

The invention concerns an apparatus for receiving microdissected specimens having at least one receptacle for collection, the apparatus being arranged displaceably in an open space defined by a stage surface of an X-Y stage and a contamination shielding panel arranged above the X-Y stage.

### BACKGROUND OF THE INVENTION

German Patent Application DE-A-100 18 251.8 describes an apparatus for laser cutting of preparations. The apparatus possesses an X-Y stage that defines a stage surface. A mount for receiving a specimen slide having a preparation is arranged on the stage surface and is joined to the X-Y stage in such a way that it is displaceable in the Y direction and the X direction. Defined between the mount and the stage surface is an open working space into which a collection apparatus, having at least one receptacle for collecting a cut-out preparation part, can be introduced. Reliable collection of the cut-out preparations (microdissected specimens) cannot be entirely guaranteed in this context, since the receptacles cannot be brought close enough to the preparation.

### SUMMARY OF THE INVENTION

It is therefore the object of the present invention to create an apparatus for the collection of microdissected specimens that ensures reliable collection of the microdissected specimens and at the same time makes possible simple and user-friendly operation.

The object is achieved by an apparatus which is characterized in that the receptacle is arranged on a separate holding element in the apparatus; and that by shifting the apparatus, one holding element at a time can be brought into a collection position.

The invention has the advantage that in one embodiment, the collection position of the holding elements is configured in such a way that the receptacle is flush with the upper plane defined by the contamination shielding panel. For that purpose, there is shaped in the contamination shielding panel a cutout through which the receptacle can be brought with a pivotable holding element to the upper plane. The upper rim of the receptacle lies flush with the upper plane. In addition, the collection position of the holding elements can be configured in such a way that the receptacle penetrates slightly through the cutout shaped in the contamination shielding panel, and thus projects beyond the upper plane defined by the contamination shielding panel.

The receptacles that are used, into which the microdissected specimens fall, generally have a cup-shaped configuration. They possess a depression in which the microdissected specimen comes to rest. One possible configuration of a receptacle is that the receptacle comprises a cover that is joined via a tab to a lower part. The cover defines a receptacle opening, and the cover is attached to the holding element in such a way that the receptacle opening faces substantially in the direction of the contamination shielding panel.

It has proven particularly advantageous that the holding elements are arranged pivotably in the drawer. A rod that is provided in the drawer defines a pivot axis about which the holding elements are pivotable. Further advantageous embodiments are evident from the dependent claims.

### BRIEF DESCRIPTION OF THE DRAWINGS

The subject matter of the invention is depicted schematically in the drawings and will be described below with reference to the Figures, in which:

FIG. 1 shows a cross section through an X-Y stage that additionally comprises an apparatus for collecting microdissected specimens;

FIG. 2 shows a perspective view of the drawer that is part of the collection apparatus;

FIG. 3 shows a perspective view of the collection apparatus, multiple holding elements being placed in the drawer;

FIG. 4 shows a bottom view of the drawer of the collection apparatus;

FIG. 5 shows a side view of an exemplary embodiment of the holding elements for the receptacle;

FIG. 6 shows a perspective view of the holding elements for the receptacles;

FIG. 7 shows a side view of a holding element that is placed in the collection apparatus, the receptacle not being in the receiving position; and

FIG. 8 shows a side view of a holding element, the receptacle being located in the receiving position.

### DETAILED DESCRIPTION OF THE INVENTION

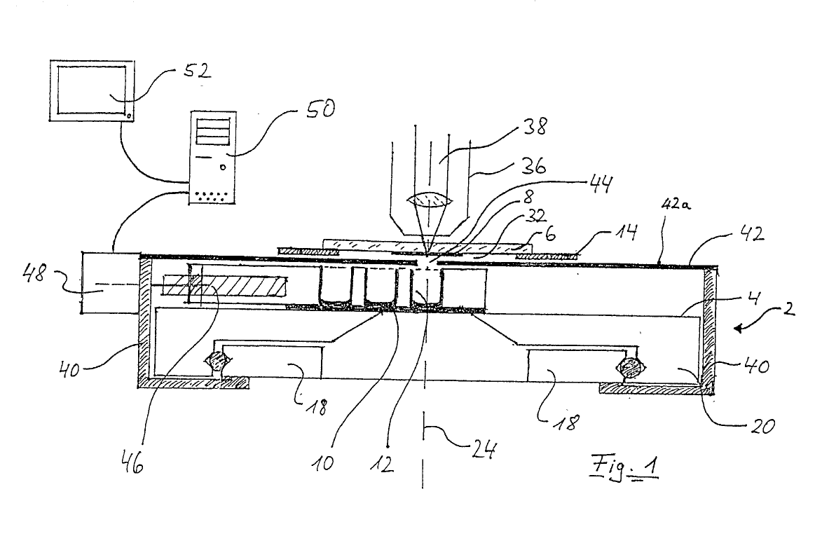

FIG. 1 depicts a cross section through an X-Y stage 2 on which stands, substantially perpendicular, an optical axis 24 defined by an objective 36. A plate 20 displaceable in the Y direction is arranged on a stationary baseplate 18. Upon displacement, baseplate 18 would move out of the drawing plane defined by FIG. 1. Displaceable plate 20 defines stage surface 4 of X-Y stage 2. Provided on stage surface 4 is an apparatus 10 for collecting the microdissected specimens, which can be equipped with an adjustment apparatus 46, 48. It is self-evident that apparatus 10 can also be moved manually in the open working space 16.

Specimen slide holder 14 defines an open space 32 above which specimen slide 6 is arranged in such a way that preparation 8 is located entirely in open space 32. When a specimen slide 6 is present on specimen slide holder 14, preparation 8 is arranged in such a way that it faces toward stage surface 4. Objective 36 of the microscope (not depicted) is associated with specimen slide 6 on optical axis 24, and generates an image of preparation 8. A coupled-in laser beam 38 is also directed onto preparation 8 through objective 36, in order to cut out of preparation 8 a small portion called the microdissected specimen. Collection apparatus 10 is located beneath preparation 8 in such a way that the cut-out portion falls directly, by gravity, into a receptacle 12 of collection apparatus 10. The number of receptacles 12 of collection apparatus 10 can be adapted to utilization conditions.

Two support elements 40 are mounted on stationary baseplate 18. Support elements 40 support a contamination shielding panel 42 that is stationary, between holder 14 and collection apparatus 10, relative to optical axis 24. Contamination shielding panel 42 defines an upper plane 42a on which specimen slide holder 14 rests. Contamination shielding panel 42 spans the entire stage surface 4 and thereby constitutes the upper boundary of open working space 16. It is equipped with a cutout 44 around optical axis 24. Collection apparatus 10 with receptacles 12 for receiving the cut-out microdissected specimens is arranged in open working space 16. Collection apparatus 10 can comprise an array of receptacles 12. Contamination shielding panel 42 prevents dust or other particles from the ambient air from becoming deposited in receptacles 12 of collection apparatus 10. In addition, contamination shielding panel 42 prevents the deposition into receptacles 12 of preparation parts released during laser cutting-out of preparation 8. It proves advantageous in this context that at all times only one receptacle 12 of apparatus 10 is open for collection through cutout 44 in contamination shielding panel, while the other receptacles 12 are covered.

Adjustment apparatus 46 is joined to collection apparatus 10, and both are arranged on stage surface 4. In addition to manual operation of adjustment apparatus 46, a motor 48 can also be provided for motorized displacement of adjustment apparatus 46 on stage surface 4. Motor 48 is connected to a computer 50 that is responsible for controlling adjustment apparatus 46. Computer 50 shifts collection apparatus 10 in such a way that the respectively desired receptacle is located beneath cutout 44 and thus beneath the region of preparation 8 that is presently being subjected to the laser cutting operation. When the laser cutting operation is complete, the cut-out microdissected specimen falls by gravity into receptacle 12. Computer 50 will, if necessary, correspondingly position another (or an empty) receptacle 12 so as thereby to collect another cut-out microdissected specimen.

Computer 50 is furthermore connected to a monitor 52. By way of monitor 52 it is possible, for example using a mouse (not depicted), to select a desired receptacle 12. For that purpose, the number and arrangement of receptacles 12 is schematically depicted on monitor 52. Contamination shielding panel 42 is provided directly beneath specimen slide holder 14, and the selected receptacle is moved beneath cutout 44 on the basis of the selection. This can take place automatically, and requires no intervention by the user.

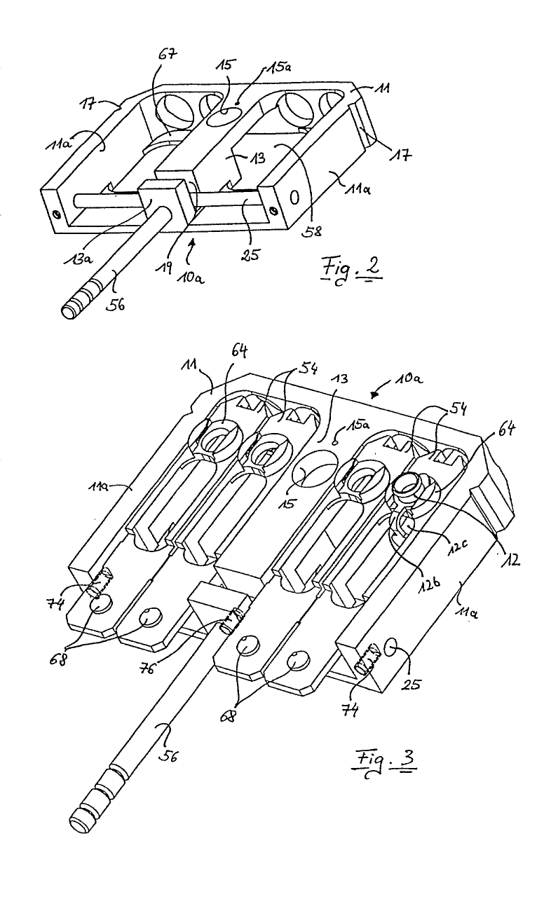

FIG. 2 presents a perspective view of a portion of collection apparatus 10. Apparatus 10 comprises a drawer 10a that comprises a frame 11 which, for example, is milled from a workpiece or is injection-molded of plastic. Frame 11 further possesses a central strut 13 that comprises an opening 15 to allow passage of an illuminating light for preparation 8, and an alignment mark 15a. The purpose of alignment mark 15a is to determine the position of apparatus 10 with respect to optical axis 24 of the microscope. Frame 11 comprises two opposite sides 11a that can be equipped with an elongated notch 17. Notches 17 define an engagement region for adjustment apparatus 46. Central strut 13 possesses a depression 19 through which a rod 25 is guided and is recessed and retained in the two sides 11a. Rod 25 is provided to mount and support holding elements 54 (see FIG. 3) for receptacles 12. Central strut 13 also defines an end surface 13a to which a handle element 56 is joined. Handle element 56 serves for handling and for introduction of drawer 10a into apparatus 10 and into X-Y stage 2. Drawer 10a additionally has a recess 58 that on the one hand provides sufficient freedom of movement for holding elements 54, and on the other hand also allows passage of the illuminating light beam (not shown) that passes through opening 15.

FIG. 3 shows drawer 10a with several holding elements 54 in place. In the exemplary embodiment depicted here, four holding elements 54 are placed into drawer 10a. It is self-evident that drawer 10a need not be configured exclusively for the reception of four holding elements 54. Holding elements 54 possess a depression 62 (see FIGS. 5 and 6) that partially fits around rod 25. Holding elements 54 are simply laid onto rod 25, and are fixed in position by depression 62 (see FIGS. 5 and 6). It is thus possible to remove holding elements 54 quickly and easily, without assembly effort, from drawer 10a and from apparatus 10. Rod 25 can be secured, for example, with screws 74 that engage into the end surface of sides 11a of drawer 10a. Handle element 56 of apparatus 10 is joined to drawer 10a with a handle screw 76. In the present exemplary embodiment, the number of holding elements 54 on the two sides of central strut 13 is identical. As already described with reference to FIG. 2, central strut 13 is equipped with an alignment mark 15a and with opening 15 for passage of the illuminating light to illuminate preparation 8 on specimen slide 6. It is also not necessary, in the context of the configuration of drawer 10a, for central strut 13 to be arranged in the center of apparatus 10. The configuration of frame 11 shown here is not to be construed in any way as a limitation. The lengths of sides 11a of drawer 10a are dimensioned such that holding elements 54, and knobs 68 arranged thereon, project out beyond them. The holding elements possess a mount 64 for a receptacle 12. Receptacle 12 possesses a cup-like shape in which the microdissected specimen is collected. In the exemplary embodiment shown, receptacle 12 is joined via a tab 12b to a lower part 12c. It is not necessary for exclusively identical or identically configured holding elements 54 to be placed into drawer 10a of apparatus 10.

A bottom view of drawer 10a is depicted in FIG. 4. Slide elements 60 are mounted on frame 11 perpendicular to axis 56a of handle element 56. Slide elements 60 are provided so that drawer 10a and the entire apparatus 10 slide smoothly on stage surface 4. Slide elements 60 are attached in such a way that they extend approximately entirely between sides 11a. Teflon™ is one possible material for configuring slide elements 60.

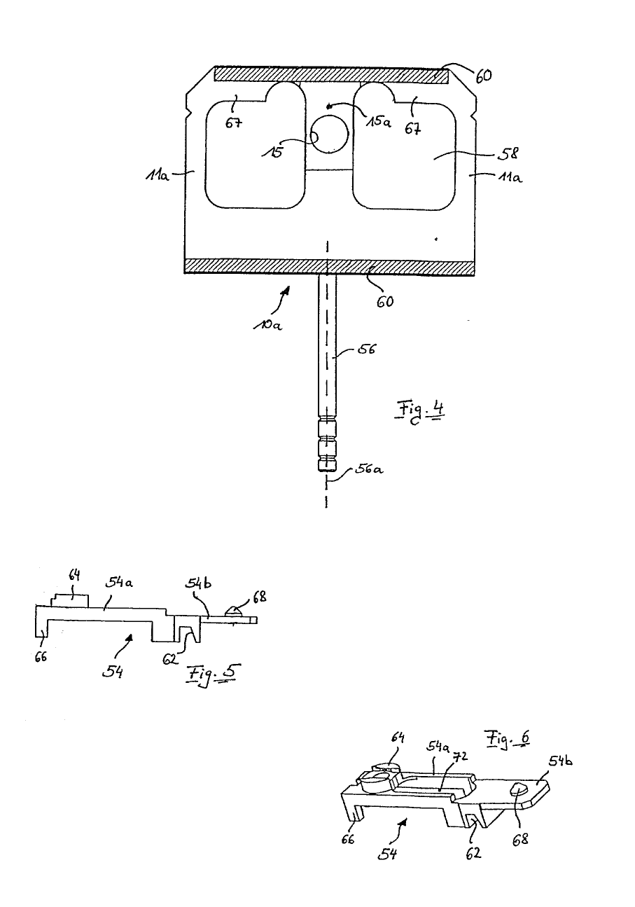

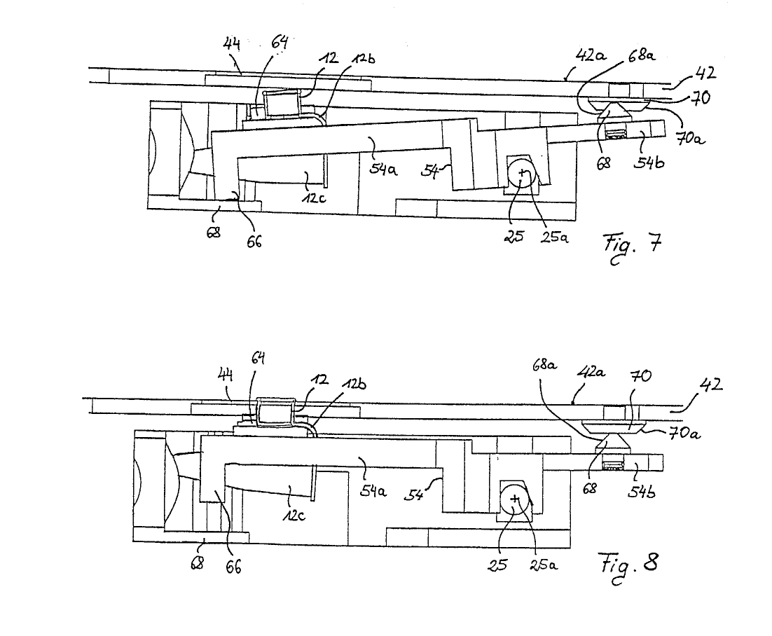

A side view of one embodiment of holding element 54 according to the present invention is depicted in FIG. 5. Holding element 54 possesses an elongated and substantially rectangular shape. The shape of the exemplary embodiment depicted here is in no way to be construed as a limitation. Holding element 54 possesses a depression 62 into which rod 25 engages. Holding element 54 can be subdivided into a first part 54a and a second part 54b. First part 54a extends to the left viewed from depression 62, and second part 54b extends to the right viewed from depression 62. The uneven mass distribution with respect to depression 62 results in a tilt of holding element 54 when rod 25 coacts with depression 62. First part 54a of holding element 54 possesses at its end a mount 64 for receptacle 12. Provided opposite mount 64 is a stop 66 that limits in the downward direction the tilt of holding element 54 in apparatus 10. Shaped in drawer 10a for this purpose is a counterelement 67 (see FIG. 2 or FIG. 4) that coacts with stop 66 and limits the inclination of holding element 54. Second part 54b of holding element 54 carries a knob 68 that, upon displacement of apparatus 10, coacts with a lug 70 (see FIG. 7 and FIG. 8) in order thereby to modify the tilt of holding element 54. Knob 68 can be configured on holding element 54, and can be made of the same material as holding element 54. Knob 68 can also be constituted of a different material from holding element 54. Materials that possess a low coefficient of friction are recommended for this purpose, so as thereby to minimize the necessary energy expenditure.

The perspective view of holding element 54 depicted in FIG. 6 possesses in first part 54a an aperture 72 that serves for reception or placement of a specially shaped receptacle 12.

FIG. 7 and FIG. 8 show apparatus 10 in interaction with contamination shielding panel 42, which has on its underside a lug 70 having a bevel 70a. As already mentioned, lug 70 coacts with knob 68 on second part 54b of holding element 54. FIG. 7 depicts the situation in which knob 68 is still located in front of lug 70 and is not yet coacting with it. Rod 25, guided by depression 62 of holding element 54, allows holding element 54 to rotate about rod 25. Because, as already mentioned in the description of FIGS. 5 and 6, first part 54a of holding element 54 has a greater mass than second part 54b, holding element 54 is tilted with respect to contamination shielding panel 42. Stop 66 of holding element 54 coacts with a corresponding counterelement 68 on drawer 10a which limits the tilt of holding element 54. A receptacle 12 is set into first part 54a of holding element 54. Receptacle 12 comprises a cover 12a that is joined via a tab 12b to a lower part 12c. Cover 12a of receptacle 12 is placed in mount 64, and lower part 12c is placed, beneath mount 64, on first part 54a of holding element 54. Cover 12a does not engage into cutout 44 in contamination shielding panel 42.

Upon further displacement of apparatus 10, as depicted in FIG. 8, knob 68 of holding element 54 comes into working engagement with lug 70 of contamination shielding panel 42. Bevel 70a of lug 70 and bevel 68a of knob 68 coact in such a way that holding element 54 is lifted and receptacle 12 is flush with at least upper plane 42a of contamination shielding panel 42. It is desirable for receptacle 12 to be brought as close as possible to preparation 8 in order to ensure reliable reception of the cut-out microdissected specimen. Receptacle 12 will then protrude through cutout 44 in contamination shielding panel 42, and be raised slightly above upper plane 42a of contamination shielding panel 42. In the exemplary embodiment depicted in FIG. 7 and FIG. 8, the coaction of lug 70 with knob 68 causes a pivoting motion of holding element 54 about axis 25a defined by rod 25. Second part 54b of holding element 54 is thereby lowered and first part 54a of holding element 54 is raised, so that receptacle 12 is brought into the position described above.

The invention was described with reference to a particular embodiment. It is nevertheless apparent that changes and modifications can be made without thereby leaving the range of protection of the claims recited hereinafter.

### PARTS LIST

2 X-Y stage

4 Stage surface

6 Specimen slide

8 Preparation

10 Collection apparatus

10a Drawer

11 Frame

11a Side

12 Receptacle

12a Cover

12b Tab

12c Lower part

12d Receptacle opening

13 Central strut

13a End surface

14 Specimen slide holder

15 Opening

15a Alignment mark

15 Open working space

17 Notch

18 Stationary baseplate

19 Depression

20 Plate displaceable in the Y direction

21 Knurled screw

22 Linear guide

22a X direction

23 Roller bearing

24 Optical axis

25 Rod

25a Axis

26 Cutout

28 First limb

30 Second limb

32 Open space

36 Objective

38 Laser beam

40 Support element

42 Contamination shielding panel

42a Upper plane of contamination shielding panel

44 Cutout

46 Adjustment apparatus

48 Motor

50 Computer

52 Monitor

54 Holding elements

54a First part

54b Second part

56 Handle element

58 Axis

58 Recess

60 Slide element

62 Depression

64 Mount

66 Stop

67 Counterelement

68 Knob

68a Bevel

70 Lug

70a Bevel

72 Recess

74 Screw

76 Handle screw

What is claimed is:

1. An apparatus (10) for receiving microdissected specimens having at least one receptacle (12) for collection, the apparatus being arranged displaceably in an open space (32) defined by a stage surface (4) of an X-Y stage (2) and a contamination shielding panel (42), wherein the receptacle (12) is arranged on a separate holding element (54) in the apparatus; and by shifting the apparatus (10), one holding element (54) at a time can be brought into a collection position.

2. The apparatus as defined in claim 1, characterized by a drawer (10a) that can be placed into the apparatus (10) together with the holding elements (54).

3. The apparatus as defined in claim 1, wherein the collection position of the holding elements (54) is configured in such a way that the receptacle (12) is flush with the upper plane (42a) defined by the contamination shielding panel (42).

4. The apparatus as defined in claim 1, wherein the collection position of the holding elements (54) is configured in such a way that the receptacle (12) penetrates through a cutout (44) shaped in the contamination shielding panel (42) and thus projects beyond the upper plane (42a) defined by the contamination shielding panel (42).

5. The apparatus as defined in claim 4, wherein the receptacle (12) comprises a cover (12a) that is joined via a tab (12b) to a lower part (12c); the cover (12) defines a receptacle opening (12d); and the cover (12a) is attached to the holding element (54) in such a way that the receptacle opening (12d) faces substantially in the direction of the contamination shielding panel (42).

6. The apparatus as defined in claim 5, wherein when a holding element (54) is raised, the receptacle opening (12d) is substantially parallel to the contamination shielding panel (42).

7. The apparatus as defined in claim 1, wherein the holding elements (54) are arranged pivotably in the drawer (10a); and a rod (25) which defines an axis (25a) about which the holding elements (54) are pivotable is provided in the drawer (10a).

8. The apparatus as defined in claim 7, wherein each of the holding elements (54) comprises a first and a second part (54a, 54b); a depression (62) that constitutes a bearing about the rod (25) is configured in the holding element (54); and the center of gravity lies in the first part (54a) of the holding element (54).

9. The apparatus as defined in claim 8, wherein a mount (64) that is configured to receive and retain the receptacle (12) is provided on the first part (54a) of the holding element (54).

10. The apparatus as defined in claim 8, wherein a stop (66), which coacts with a corresponding counterelement of the drawer (10a) in order to limit the tilt of the holding element (54), is provided on the first part (54a) of the holding element (54).

11. The apparatus as defined in claim 7, wherein the holding elements (54) rest loosely on the rod (25) by means of a depression (62); and the holding elements (54) can be removed from the drawer (10a) without assembly work.
